(19) United States
(12) Patent Application Publication
(10) Pub. No.: US 2007/0286769 A1
(43) Pub. Date: Dec. 13, 2007

(54) PARALLEL NANO-DIFFERENTIAL SCANNING CALORIMETRY

(76) Inventors: Joost J. Vlassak, Lexington, MA (US); Patrick James McCluskey, Cambridge, MA (US)

Correspondence Address: GAUTHIER & CONNORS, LLP, 225 FRANKLIN STREET, SUITE 2300, BOSTON, MA, 02110, US

(21) Appl. No.: 11/759,497

(22) Filed: Jun. 7, 2007

Related U.S. Application Data
(60) Provisional application No. 60/811,634, filed on Jun. 7, 2006.

(51) Int. Cl. G01N 25/20

(52) U.S. Cl. 422/51

(57) ABSTRACT

A calorimetric system includes a plurality of cell structures being used to define a selective region for calorimetric measurements of a nano-structure. Heating units are positioned on the cell structures to provide the necessary energy needed to perform calorimetric measurements in each of the cell structures. The cell structures and the heating units are arranged so as to allow the calorimetric system to perform, in combinatorial fashion, calorimetric measurements associated with the nano-structure.

### PRIORITY INFORMATION

This application claims priority from provisional application Ser. No. 60/811,634 filed Jun. 7, 2006, which is incorporated herein by reference in its entirety.

### BACKGROUND OF THE INVENTION

This invention relates to field of calorimetry, and in particular to a calorimetric system for the combinatorial analysis of complex nano-scale material systems.

Calorimetry is a primary technique for measuring the thermal properties of materials. A typical calorimeter system requires relatively large amounts of test material, making thermal measurements on nano-scale samples difficult if not impossible. Thus, while traditional calorimetry has proved a very useful technique, its application in nanotechnology, where sample sizes can be very small, is rather limited. Since the properties of materials on the nano-scale may differ significantly from their bulk counterparts, a calorimeter system that is sensitive enough to probe nano-scale quantities is desirable. Furthermore, traditional calorimeter systems are limited to taking one measurement at a time, and a new sample must be loaded between each measurement. This severely limits the use of a traditional calorimeter in combinatorial studies at the nano-scale. To obtain reasonable precision on thermal properties as a function of composition many samples must be measured. Anything beyond a binary material system quickly involves unreasonable amounts of time to perform a full analysis.

### SUMMARY OF THE INVENTION

According to one aspect of the invention, there is provided a calorimetric system. The calorimetric system includes a plurality of cell structures being used to define a selective region for calorimetric measurements of a nano-structure. Heating units are positioned on the cell structures to provide the necessary energy to perform calorimetric measurements in each of the cell structures. The cell structures and the heating units are arranged so as to allow the calorimetric system to perform, in combinatorial fashion, calorimetric measurements associated with the nano-structure.

According to another aspect of the invention, there is provided a method of forming a calorimetric system. The method includes forming a plurality of cell structures being used to define a selective region for calorimetric measurements of a nano-structure. Also, the method includes forming a plurality of heating units positioned on the cell structures to provide the necessary energy needed to perform calorimetric measurements in each of the cell structures. The cell structures and the heating units are arranged so as to allow the calorimetric system to perform, in combinatorial fashion, calorimetric measurements associated with the nano-structure.

According to another aspect of the invention, there is provided a method of performing calorimetric measurements of a nano-structure. The method includes defining a plurality of selective regions for calorimetric measurements of the nano-structure. Also, the method includes providing the necessary energy needed to perform calorimetric measurements to the selective regions. Furthermore, the method includes performing in combinatorial fashion calorimetric measurements associated with the nano-structure from the selective regions.

### BRIEF DESCRIPTION OF THE DRAWINGS

FIG. 1A is a photograph of the parallel nano-differential scanning calorimeter (PnDSC) system; FIG. 1B is a schematic diagram of a calorimetric cell;

FIG. 2 is a schematic diagram of scanning calorimetry measurement;

FIG. 3 is a schematic diagram of a differential measurement;

FIG. 4 is a logarithmic plot of the fractional error in heat capacity of the sample versus normalized sample size;

FIG. 5 is a schematic diagram of an actively controlled current source used in accordance with invention;

FIG. 6A is a graph demonstrating current monitoring voltage across 100Ω precision resistor; FIG. 6B is a graph demonstrating voltage response of heating element; FIG. 6C is a graph demonstrating specific heat measurement of NiTi; and

FIG. 7 is a graph demonstrating the result of a SC measurement of the melting peak of a 25 nm In film.

### DETAILED DESCRIPTION OF THE INVENTION

The invention provides a calorimetric system used for the combinatorial analysis of complex nano-scale material systems. The parallel nano-differential scanning calorimeter (PnDSC) system is a micro-machined array of calorimetric cells. This new approach to combinatorial calorimetry greatly expedites the analysis of nano-scale material thermal properties. A power-compensation differential scanning calorimetry measurement is described. The scanning calorimetry capability of the PnDSC is demonstrated by a specific heat measurement of an equiatomic NiTi thin film and melting peak measurement of 25 nm thin film In.

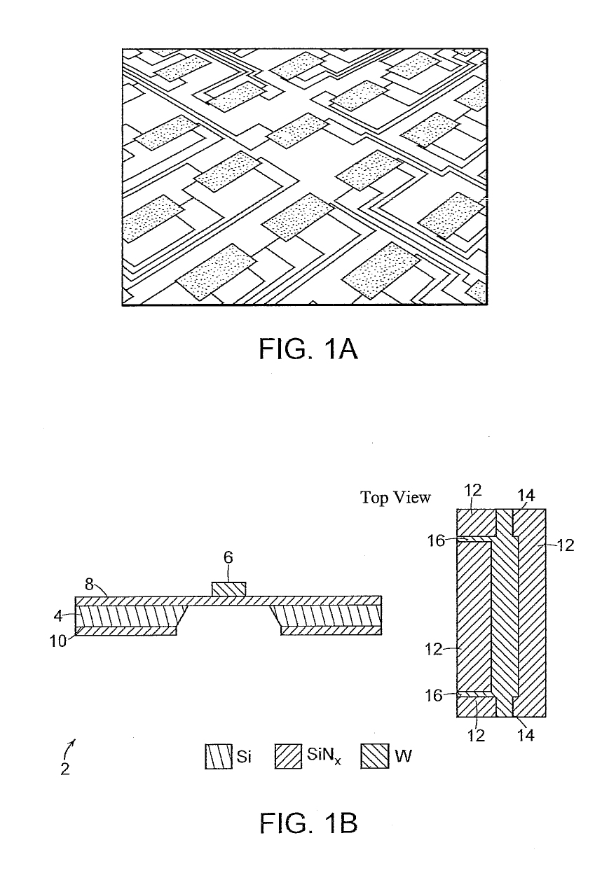

The PnDSC combines DSC and combinatorial analysis in a novel way. This system is ideal for studying complex material systems. The heart of the PNDSC measurement system is a micro-machined, 5×5 array of calorimetric cells, as shown in FIG. 1A. The PnDSC and complimentary measurement system reduce the analysis time of complex nano-scale material systems by at least an order of magnitude.

A thin (˜100 nm) silicon nitride film 8 is continuous across the surface of the PNDSC measurement system 2, as shown in FIG. 1B. Portions of this film 8 are freestanding, creating the membrane 12 of the calorimetric cells. The membranes 12 are positioned uniformly across the PnDSC measurement system 2. Each cell has planar dimensions of approximately 2.5×5 mm. A thin-film (˜150 nm) metal strip (width ˜400 μm), typically W, is patterned on the membrane 12, which serves as a heater and resistive thermistor 6 in a four-point measurement scheme. Leads 14 patterned from the same metallization layer, attach close to the ends of the thermistor 6. Probe lines 16 allow electrical signals to travel from each heating element and probe across the frame to electrical contacting pads at the edge of the PnDSC measurement system 2. A second metallization layer, typically Al, supplements the metallization layer of the heating element 6 in the lead lines and contact pads to reduce electrical resistance and facilitate electrical contacting to the PnDSC measurement system 2.

The fabrication process uses ˜800 μm thick, 8″ Si wafers polished on one side. These wafers are delivered with ˜100 nm silicon nitride thin films 8, 10 on both sides. Special care is taken throughout the fabrication process to protect the silicon nitride film 8 on the polished side of the wafer 4. This film will eventually form the membranes 12 of the PnDSC system 2 and even shallow scratches result in ruptured membranes.

The fabrication process starts by cleaving each wafer 4 into 7, 5.5 cm square partitions. First tungsten then aluminum is deposited on the polished side of the square wafer 4 using a magnetron sputtering system. Shipley 1805 photoresist (S1805) is spun and patterned on both sides of the wafer 4. The silicon nitride 10 on the backside of the wafer 4 is reactively etched with CF₄ to create rectangular windows. Al is etched using a commercial Al wet etch. This exposes the underlying W, which is then etched with H₂O₂. Remaining resist is developed and removed. S1805 is re-spun on the metallization side and patterned with the rectangular window artwork. Al is then etched from the membrane area 12.

After the metallization patterning, the membranes 12 are created by anisotropically etching the Si wafer 4. The metallization is protected during this etch procedure by a specially designed sample holder. This fabrication process differs from that used by the prior art in that the Si etch is performed near the end of the fabrication rather than near the beginning. This protects the delicate membranes 12 from being exposed until the very end of the fabrication and allows more complicated processing on the polished side of the wafer 4.

The calorimetric cell has been modeled by a one-dimensional transient thermal model. This model considers effects from thermal mass, conduction, radiation and Joule heating to give the time-dependent temperature profile of the heating element. Using this temperature profile conclusions can be made about the performance of the calorimetric cell, such as; heat loss rates, temperature uniformity, and signal noise levels. Figures of merit as functions of design parameters (e.g. device dimensions/materials) were developed to explore these important characteristics of the design.

The array design allows the PnDSC system to perform combinatorial studies with great efficiency. Current fabrication techniques produce 25 calorimetric cells on each PnDSC system. This allows for 25 samples of unique composition to be prepared simultaneously. This is accomplished conveniently by using a multi-gun sputtering system, although other techniques can be used as well. When material is deposited through a shadow mask on the surface of the PnDSC system, an array of samples is created with 25 unique compositions. These samples can then be measured sequentially without the need to reload between measurements. The measurement sequence can be selected manually or computer controlled for full automation.

Power input and temperature are the essential values for a calorimetric thermal measurement. EQ. 1 shows heat capacity (C_{P}) as a function of power supplied to a cell (P) and the heating rate (dT/dt):

$${C}_{P} = \frac{P}{ⅆ T / ⅆ t} \qquad EQ . 1$$

The sensitivity of the thermal measurement depends on how these values are obtained. The sensors in the PnDSC can be operated in 3 modes: scanning calorimetry (SC), differential thermal analysis (DTA), and differential scanning calorimetry (DSC).

SC is the least sensitive measurement type, but it offers the greatest compositional precision and is the simplest measurement to take. Two separate measurements must be performed to obtain the heat capacity of the sample, one with and one without the sample. The heat capacity of the sample is then equal to the difference of the two. SC is sufficient to measure a sample with large thermal mass or a large enthalpy of reaction, relative to the heat capacity of the bare calorimetric cell (C_{P}^{A}).

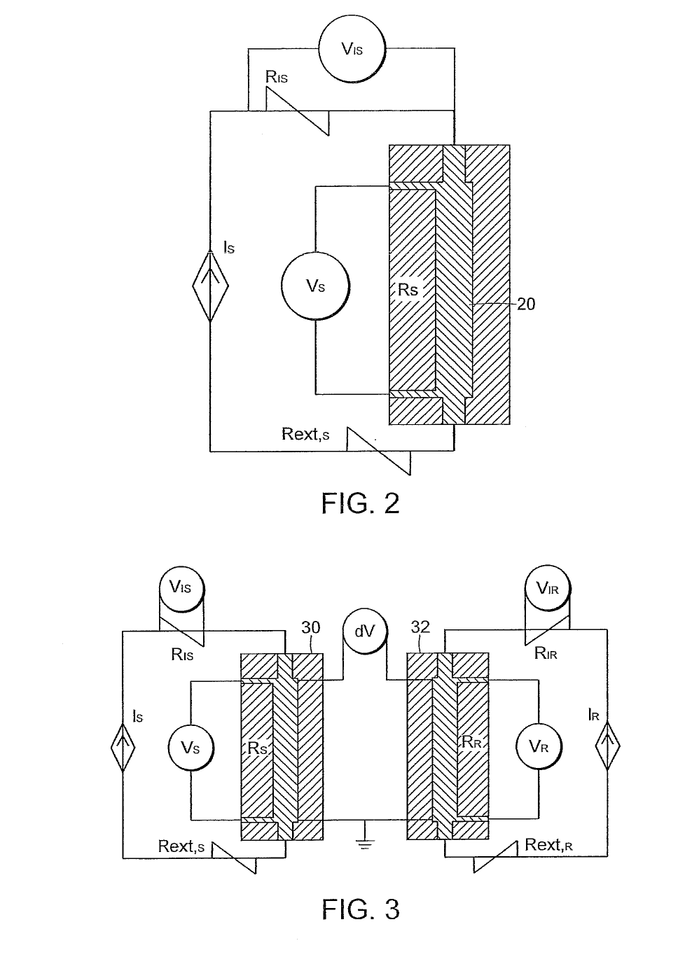

As in prior art, a current (I_{S}) through the heating element 20 provides Joule heating to the calorimetric cell. The current is measured (V_{IS}) across an external precision resistor (R_{IS}). The voltage (V_{S}) across the heating element 20 is measured via two sense probes, as shown in FIG. 2. In this way, the resistance at room temperature (R_{S0}) and the resistance as a function of temperature (R_{S}) of the heating element and power supplied can be easily calculated. The temperature of the cell is then determined from the thermal coefficient of resistivity (α). Thus, power and temperature are determined and heat capacity can be calculated, see EQs. 2 & 3.

$$\begin{matrix}P = {I}_{s} * {V}_{s} & EQ . 2 \\ \frac{ⅆ T}{ⅆ t} = \frac{{R}_{S}}{α \cdot {R}_{S 0}} ( \frac{1}{{V}_{S}} \frac{ⅆ {V}_{S}}{ⅆ t} - \frac{1}{{V}_{IS}} \frac{ⅆ {V}_{IS}}{ⅆ t} ) & EQ . 3\end{matrix}$$

Samples on the order of nanograms require greater sensitivity than a single cell measurement can provide. For this case a differential measurement is required as shown in FIG. 3. A current (I_{S}) through the heating element 30 provides Joule heating to the calorimetric cell. The current is measured (V_{IS}) across an external precision resistor (R_{IS}). The voltage (V_{S}) across the heating element 30 is measured via two sense probe, as shown in FIG. 3. In this way, the resistance of the heating element (R_{S}) and power supplied can be easily calculated. The temperature of the cell is then determined from the thermal coefficient of resistivity (α). A current (I_{R}) through the reference heating element 32 provides Joule heating to the calorimetric cell. The current is measured (V_{IR}) across an external precision resistor (R_{IR}). The voltage (V_{R}) across the heating element 32 is measured via two sense probe. The resistance (R_{R}) of the heating element and power supplied can be easily calculated. The temperature of the cell is then determined from the thermal coefficient of resistivity (α).

In DTA mode, as in prior art, decoupled current sources I_{S}, I_{R} apply equivalent currents to a reference cell (R_{R}) and a cell (R_{S}) with sample. The current supplied and the voltage drop across the sensing portion of the heaters is measured similarly to the non-differential mode. A fifth differential voltage (dV) is measured on the high voltage side of the heating elements 30, 32. This differential voltage (dV) allows a more sensitive heat capacity measurement because the temperature difference is measured directly, rather than independently, and subtracted after the fact.

A sample with a thermal mass comparable to ˜10% of the addendum or an enthalpy of reaction which produces a peak in the C_{P} curve with a height of ˜10% C_{P}^{A} is best measured using a true DSC measurement approach. The DSC measurement is similar to DTA, however, the current to the cell with sample (R_{S}) is actively controlled. This technique compensates for the additional heat capacity of the sample and the enthalpy of reaction by actively controlling the power required to maintain equivalent heating rates between the sample (R_{S}) and reference cells (R_{R}).

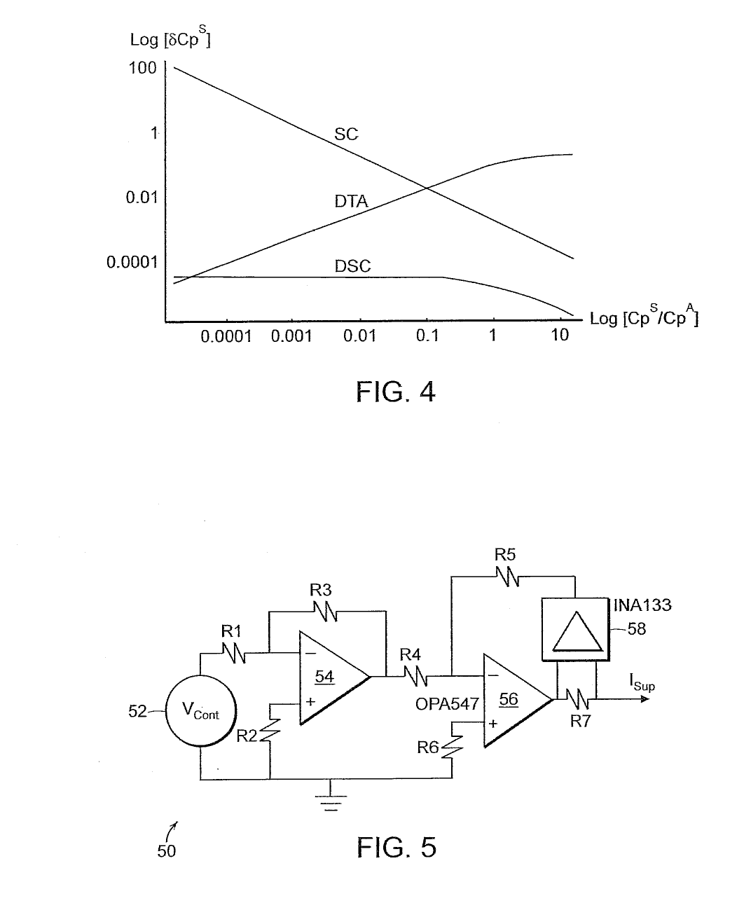

Maintaining the cells at the same temperature has a dramatic effect on error in differential measurements. FIG. 4 shows the fractional error in heat capacity as a function of normalized sample size. Idealized error estimates in measured quantities were assumed equal to the resolution of an 18 bit analog to digital converter. SC and DTA error estimates and DSC error estimates were calculated using an error propagation analysis of the describing equations. An additional error term was added to the DTA measurement to account for the disparity in heating rate between the sample and reference cell. DSC outperforms both measurement techniques for all but the smallest samples, where DTA has the lowest error.

The desired signals in a nano-calorimetric measurement require specialized electronics. The calorimetric cell has a thermal diffusion time constant on the order of milliseconds. In order to assume adiabatic conditions heating rates must be at least an order of magnitude greater than cooling rates. This requires heating rates greater than 10 K/ms. To obtain a reasonable resolution of the temperature requires a fast data acquisition board (DAQ). Also measuring the desired quantities in nano-samples requires a resolution of ˜10 μV in a ˜1V signal. This requires careful signal conditioning and isolation.

Attached to the vacuum chamber containing the PnDSC is a sensor interface subsystem. This unit serves to shield the weak device signals from the noisy laboratory environment. Housed in this compartment are voltage amplifiers and MOSFET switches for each sensor. Attached to the sensor interface subsystem is a current control unit. FIG. 5 depicts the current source used in SC mode; the control voltage (V_{Cont}) is from the analog output on the DAQ board. Differential measurements require decoupled current sources to avoid introducing spurious signals in the differential voltage measurement. In DSC mode one of the low-noise decoupled current supplies will be supplemented by a low noise version of the actively controlled current source to regulate the heating rate.

One can anticipate using a custom data acquisition system with five 18 bit analog inputs and two outputs at 333 kHz per channel. After the signal has been digitized it will be sent over a custom fiber link to a custom fiber net board. This assures galvanic isolation from PC noise. The DAQ will also include a number of digital outputs for timing and analog switch control.

While the entire measurement system is not yet fully operational, enough has been completed to perform SC type measurement, as shown in FIG. 2. SC is used to measure the specific heat of amorphous equiatomic NiTi thin film. The current source 50 used is shown in FIG. 5. The current source 50 includes a continuous voltage source 52 to resistor (R1) and resistor (R2). The resistor (R1) is coupled to the inverting node of an operational amplifier (op-amp) 54, and the resistor (R2) is coupled to the non-inverting node of op-amp 54 and ground. A resistor (R3) is coupled to resistor (R1) and the inverting node of op-amp 54 as well as the output of the op-amp 54. A resistor (R4) is coupled to the output of the op-amp 54 and the inverting node of an op-amp 56. A resistor (R6) is coupled to the non-inverting node of op-amp 56 and ground. A resistor (R5) is coupled to resistor (R4) and the inverting node of op-amp 56 as well as a voltage regulator 58. A resistor (R7) is coupled to the output of the op-amp 56 as well as being coupled to the voltage regulator 58 at both of its ends. In the embodiment, op-amps 54, 56 include the op-amp OPA547 manufactured by Analog Devices, however, other op-amps can be used in this invention.

In the present DAQ, voltage signals are unconditioned; they are measured and controlled by a National Instruments PCI-6221 board. Measurements were performed in a vacuum chamber at ˜1*10⁻⁵ Torr.

Before a thermal measurement can be performed, the thermal coefficient of resistivity, α, must be determined. Prior to operation, the device was annealed at 450° C. for 1 hour in a vacuum of ˜1*10⁻⁶ Torr to stabilize electrical behavior. The calibration setup is identical to the experimental setup with the additional condition that the device is in an oven and an independent thermocouple is used to measure the temperature. A small monitoring current (1 mA) is applied to the device while the temperature of the oven is slowly stepped through a temperature range. This current and the resulting voltage drop across the heating element are used to calculate resistance. Resistance is then calibrated to the temperature reading of the thermocouple. This resulted in a thermal coefficient of resistivity, α=8.5*10⁻⁴ K⁻¹. This is approximately 20% of the bulk value of W. This is caused by the extremely fine grain structure of the W film, which increases its resistivity and reduces the thermal coefficient of resistivity.

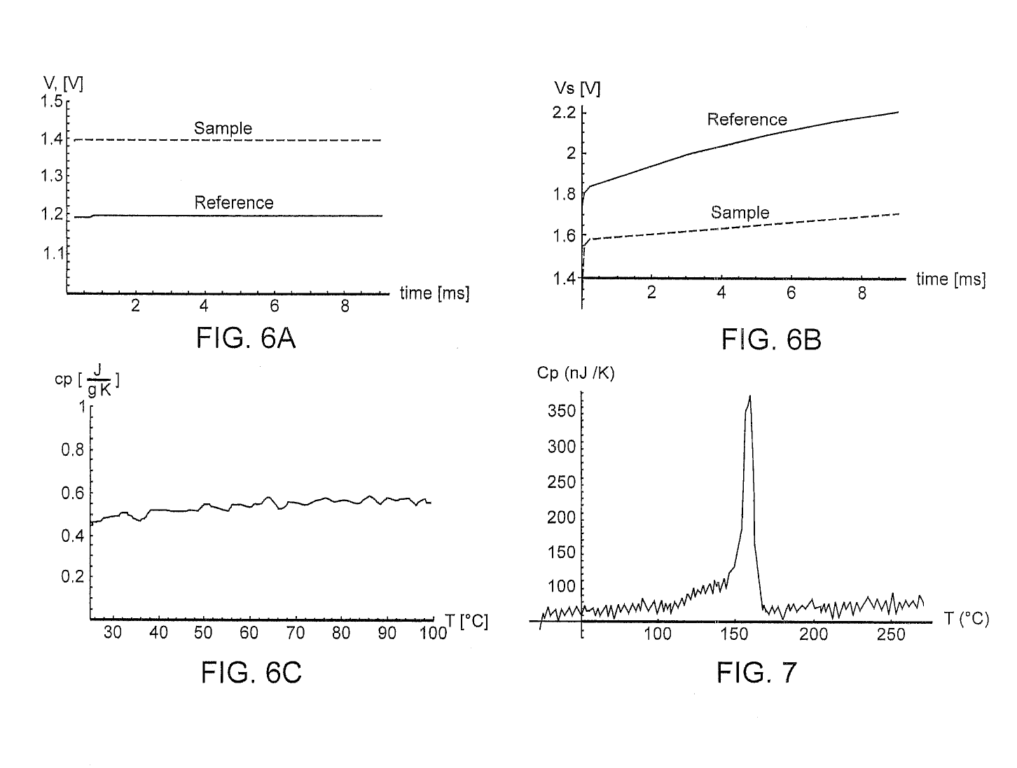

Measuring the specific heat of NiTi requires establishing a heat capacity baseline. To acquire this baseline, a 10 mA current pulse lasting 10 ms was applied to the reference cell. A 280 nm NiTi coating was then deposited at 1.5 mTorr on the backside of the PnDSC through a micro-machined shadow mask. A current pulse of 14 mA was applied to the sample cell. The increased current partially compensates for the additional thermal mass of the sample, and reduces the heating disparity. The current monitoring voltage and voltage response of each cell, averaged over 100 cycles, was recorded at 100 kHz and is shown in FIG. 6A and 6B respectively.

Using EQs. 1-3 and a sample mass of 2.4 μg, the specific heat of NiTi is calculated as shown in FIG. 6C. For comparison, the specific heat NiTi has been reported as c_{P}=0.32-0.84 J/g ° C. Also FIG. 7 shows the result of a SC measurement of the melting peak of a 25 nm In film. These measurements are an initial demonstration of the capabilities of the PnDSC.

The PNDSC system is a new measurement device for studying complex nano-scale material systems. The device promises to revolutionize the development of such material systems, providing the raw material data for nano-technology innovation and design. The PnDSC system will accomplish this by employing a 5×5 array of micro-machined calorimetric cells. Moreover, the PnDSC system can include a heating element in a double spiral pattern. This layout will improve the thermal efficiency of the system and expand its capability for kinetic studies. Incorporation of new materials such as vanadium oxide, which has a thermal coefficient of resistivity of approximately 2%/K, will increase temperature measurement sensitivity, especially in the range relevant for biological materials. Integration of the device with microfluidic channels will expand its applicability to fluid samples.

Although the present invention has been shown and described with respect to several preferred embodiments thereof, various changes, omissions and additions to the form and detail thereof, may be made therein, without departing from the spirit and scope of the invention.

What is claimed is:

1. A calorimetric system comprising:
a plurality of cell structures being used to define a selective region for calorimetric measurements of a nano-structure; and
a plurality of heating units positioned on said cell structures to provide the necessary energy needed to perform calorimetric measurements in each of said cell structures;
said cell structures and said heating units are arranged so as to allow said calorimetric system to compute, in combinatorial fashion, calorimetric measurements associated with said nano-structure.

2. The calorimetric system of claim 1, wherein said cell structures comprise silicon nitride.

3. The calorimetric system of claim 1, wherein said cell structures comprise planar dimensions of approximately 2.5×5 mm.

4. The calorimetric system of claim 1, wherein said heater units serve as a heating and resistive thermistor to said cell structures.

5. The calorimetric system of claim 1, wherein said cell structures perform 25 samples of unique composition to be prepared simultaneously.

6. The calorimetric system of claim 1, wherein said cell structures and heating units are arranged to perform differential voltage measurements.

7. The calorimetric system of claim 1, wherein said calorimetric system performs scanning calorimetry (SC) analysis, differential thermal analysis (DTA), and differential scanning calorimetry (DSC) analysis.

8. The calorimetric system of claim 1, wherein said cell structures use decoupled current sources to apply equivalent currents to a reference cell and a cell with a sample.

9. The calorimetric system of claim 6, wherein said differential voltage measurements permit sensitive heat capacity measurements to be computed for said nano-structure.

10. The calorimetric system of claim 6, wherein said differential voltage measurements are performed on the high voltage side of said heating elements.

11. A method of performing calorimetric measurements of a nano-structure comprising:
defining a plurality of selective regions for calorimetric measurements of said nano-structure;
providing the necessary energy needed to perform calorimetric measurements to said selective regions; and
performing in combinatorial fashion, calorimetric measurements associated with said nano-structure from said selective regions.

12. The method of claim 11, wherein said selective regions comprise silicon nitride.

13. The method of claim 11, wherein said selective regions comprise planar dimensions of approximately 2.5×5 mm.

14. The method of claim 11, wherein said heater units serve as a heating and resistive thermistor to said cell structures.

15. The method of claim 11, wherein said selective regions perform 25 samples of unique composition to be prepared simultaneously.

16. The method of claim 11, wherein said selective regions are arranged to perform differential voltage measurements.

17. The method of claim 11, wherein said calorimetric measurements comprise scanning calorimetry (SC) analysis, differential thermal analysis (DTA), and differential scanning calorimetry (DSC) analysis.

18. The method of claim 11, wherein said selective regions use decoupled current sources to apply equivalent currents to a reference cell and a cell with a sample.

19. The method of claim 16, wherein said differential voltage measurements permits sensitive heat capacity measurements to be computed for said nano-structure.

20. The method of claim 16, wherein said differential voltage measurements are performed on the high voltage side of said heating elements.

21. A method of forming a calorimetric system comprising:
forming a plurality of cell structures being used to define a selective region for calorimetric measurements of a nano-structure;
forming a plurality of heating units positioned on said cell structures to provide the necessary energy needed to perform calorimetric measurements in each of said cell structures; and
arranging said cell structures and said heating units so as to allow said calorimetric system to perform, in combinatorial fashion, calorimetric measurements associated with said nano-structure.

22. The calorimetric system of claim 21, wherein said cell structures comprise silicon nitride.

23. The calorimetric system of claim 21, wherein said cell structures comprise planar dimensions of approximately 2.5×5 mm.

24. The calorimetric system of claim 21, wherein said heater units serve as a heating and resistive thermistor to said cell structures.

25. The calorimetric system of claim 21, wherein said cell structures perform 25 samples of unique composition to be prepared simultaneously.

26. The calorimetric system of claim 21, wherein said cell structures and heating units are arranged to perform differential voltage measurements.

27. The calorimetric system of claim 21, wherein said calorimetric system performs scanning calorimetry (SC) analysis, differential thermal analysis (DTA), and differential scanning calorimetry (DSC) analysis.

28. The calorimetric system of claim 21, wherein said cell structures use decoupled current sources to apply equivalent currents to a reference cell and a cell with a sample.

29. The calorimetric system of claim 26, wherein said differential voltage measurements permit sensitive heat capacity measurements to be computed for said nano-structure.

30. The calorimetric system of claim 26, wherein said differential voltage measurements are performed on the high voltage side of said heating elements.
